(19) United States
(12) Patent Application Publication
(10) Pub. No.: US 2026/0157919 A1
(43) Pub. Date: Jun. 11, 2026

(54) MASSAGE BALL WITH IMPROVED HEAT TRANSFER PERFORMANCE

(71) Applicant: CERAGEM Co., Ltd., Cheonan-si, Chungcheongnam-do (KR)

(72) Inventors: Joong Keun AN, Suwon-si, Gyeonggi-do (KR); Han Soo KIM, Seoul (KR); Jang Won YOON, Hwaseong-si, Gyeonggi-do (KR); Kyung Jin LEE, Anyang-si, Gyeonggi-do (KR); Geun Yong JUNG, Yongin-si, Gyeonggi-do (KR); June Gu JEONG, Incheon (KR)

(21) Appl. No.: 18/708,986

(22) PCT Filed: Mar. 12, 2024
(86) PCT No.: PCT/KR2024/003151

§ 371 Date: May 9, 2024

(30) Foreign Application Priority Data
Apr. 18, 2023 (KR) 10-2023-0050628

(51) Int. Cl. A61H 15/02; A61H 15/00

(52) U.S. Cl. CPC A61H 15/02; A61H 15/0078; A61H 2015/0042; A61H 2201/0207; A61H 2205/081

(57) ABSTRACT

The present invention relates to a massage ball, and more particularly, to a massage ball with improved heat transfer performance. The massage ball with improved heat transfer performance according to one aspect of the present invention includes a heating member, a rotating member rotatably disposed on an outer surface of the heating member, and an outer cover rotatably disposed on an outer surface of the rotating member.

### TECHNICAL FIELD

The present invention relates to a massage ball, and more particularly, to a massage ball with improved heat transfer performance.

### BACKGROUND ART

Conventionally, a spinal thermal massage device is widely used to alleviate acute or chronic pain generated in muscles and nerve tissues of spinal region caused by continuing to work in an inappropriate posture for a long time or by habituation of these postures, and to move along a body part for the purpose of improving the blood circulation of the body or relieve instantaneous muscle stiffness, and to improve blood flow by applying heat stimulation to the site of pain.

The spinal thermal massage device is provided with a massage ball capable of generating heat to apply stimulation by thermal heat while pressing the user. A positive temperature co-efficient (PTC) heater is provided in the center of the massage ball, which heats when current is applied.

However, the PTC heater is fixed in a non-rotating state to the center of the massage ball for power connection. However, with this configuration, there is a problem in that a fine gap is formed between the PTC heater fixed in a non-rotating state and the rotatably arranged massage ball to allow relative rotation, thereby reducing a thermal massage effect.

At this time, the PTC heater and the massage ball may be disposed in contact with each other so that heat is transferred between the PTC heater and the massage ball in a conduction manner. However, with this configuration, there is a problem in that noise due to friction may be generated during the rotation of the massage balls, and durability may deteriorate as wear and tear occur between them.

Therefore, there is a need to develop a technology that can solve these problems.

### DISCLOSURE

### Technical Tasks

The present invention is intended to solve the above problems, the purpose of the present invention is to provide a massage ball with improved heat transfer performance that can sufficiently transfer heat to a user and enable smooth rotation of the massage ball, and a massage ball with improved heat transfer performance including the same.

The technical problems of the present invention are not limited to the above-mentioned technical problems, and other technical problems not mentioned herein can be clearly understood by those skilled in the art from the following description.

### Technical Solution

A massage ball with improved heat transfer performance according to one aspect of the present invention is the massage ball providing a thermal massage effect while pressing a user, the massage ball includes a heating member, a rotating member rotatably inserted into the heating member, and an outer cover rotatably disposed on an outer surface of the rotating member.

In this case, the heating member may include a heater, and a heater cover disposed to surround the heater, and having a heat transfer surface on an outer surface thereof.

In this case, the heater cover may include a first cover disposed on one side in a radial direction, and a second cover disposed on the other side in the radial direction and coupled to the first cover, and wherein the heater is disposed between the first cover and the second cover.

In this case, the rotating member may be provided with a rotating pin inserted into the heater cover along an axial direction.

In this case, the heating member may be provided with a slot into which the rotating member is inserted, and an outer opening may be provided outside a radial direction of the slot so that a part of the rotating member is exposed in the radial direction.

In this case, the rotating member may be provided with an exposed contact portion that is exposed to the outside of the radial direction through the outer opening.

In this case, the slot may include at least one of a first slot extending from one side to the other side in an axial direction, and a second slot extending from the other side to the one side in the axial direction.

In this case, the slot may include a first slot extending from one side to the other side in an axial direction, and a second slot extending from the other side to the one side in the axial direction, and wherein the first slot and the second slot may be alternately disposed along a circumferential direction or disposed along the axial direction.

In this case, the massage ball may further include at least one of a first side plate disposed on one side in an axial direction, and a second side plate disposed on the other side in the axial direction.

In this case, the heater cover may be provided with an opening hole extending along an axial direction.

In this case, a first insert may be provided on an inner surface of the outer cover.

In this case, a second insert may be provided in a central portion of the outer cover in an axial direction.

In this case, a first cushion layer may be provided on the inside of the outer cover in a radial direction based on the second insert, and a second cushion layer may be provided on the outside of the outer cover in the radial direction.

In this case, a first insert may be provided on an inner surface of the outer cover, and a second insert may be provided in a central portion of the outer cover in an axial direction.

In this case, a first cushion layer may be provided between the first insert and the second insert, and a second cushion layer may be provided on the outside of the outer cover in a radial direction.

In this case, the rotating member may be inserted into the heating member and the outer cover.

A massage ball with improved heat transfer performance according to another aspect of the present invention is the massage ball providing a thermal massage effect while pressing a user, the massage ball includes a heating member, an outer cover rotatably disposed on an outer surface of the heating member, and a rotating member rotatably inserted into the outer cover.

In this case, the heating member may include a heater, and a heater cover disposed to surround the heater, and having a heat transfer surface on an outer surface thereof.

In this case, the heater cover may include a first cover disposed on one side in a radial direction, and a second cover disposed on the other side in the radial direction and coupled to the first cover, and wherein the heater may be disposed between the first cover and the second cover.

In this case, the rotating member may be provided with a rotating pin inserted into the outer cover along an axial direction.

In this case, the outer cover may be provided with a cover slot into which the rotating member is inserted, and a cover opening may be provided inside a radial direction of the cover slot so that a part of the rotating member is exposed in the radial direction.

In this case, the rotating member may be provided with an exposed contact portion that is exposed inward in the radial direction through the cover opening.

In this case, the cover slot may include at least one of a first cover slot extending from one side to the other side in an axial direction, and a second cover slot extending from the other side to the one side in the axial direction.

In this case, the cover slot may include a first cover slot extending from one side to the other side in an axial direction, and a second cover slot extending from the other side to the one side in the axial direction, and wherein the first cover slot and the second cover slot may be alternately disposed along a circumferential direction or disposed along the axial direction.

In this case, the massage ball may further include at least one of a first side plate disposed on one side in an axial direction, and a second side plate disposed on the other side in the axial direction.

In this case, the heater cover may be provided with an opening hole extending along an axial direction.

In this case, a first insert may be provided on an inner surface of the outer cover.

In this case, a second insert may be provided in a central portion of the outer cover in an axial direction.

In this case, a first cushion layer may be provided on the inside of the outer cover in a radial direction based on the second insert, and a second cushion layer may be provided on the outside of the outer cover in the radial direction.

In this case, a first cushion layer may be provided on the inside of the outer cover in a radial direction based on the second insert, and a second cushion layer may be provided on the outside of the outer cover in the radial direction.

In this case, a first insert may be provided on an inner surface of the outer cover, and a second insert may be provided in a central portion of the outer cover in an axial direction.

### Advantageous Effects

According to the above configuration, the massage ball with improved heat transfer performance according to the embodiment of the present invention is provided with a rotating member rotatably inserted into the heating member and an outer cover rotatably disposed on the outer surface of the rotating member, so that heat is transferred through the rotating member in a conduction manner, thereby improving the thermal massage effect, as well as the outer cover may rotate smoothly through the rotating member, so that no noise is generated during use, and durability problems due to wear and tear do not occur.

It should be understood that the effects of the disclosure are not limited to the above-described effects, and include all effects that can be inferred from the configuration of the invention described in the detailed description or claims of the disclosure.

### BRIEF DESCRIPTION OF THE DRAWINGS

FIG. 1 is a perspective view illustrating an assembled state of a massage ball with improved heat transfer performance according to an embodiment of the present invention.

FIG. 2 is a perspective view illustrating a state in which the outer cover of the massage ball with improved heat transfer performance is removed according to an embodiment of the present invention.

FIG. 3 is a perspective view illustrating a heating member according to an embodiment of the present invention.

FIG. 4 is a front view illustrating a heating member according to an embodiment of the present invention.

FIG. 5 is a front view enlarged illustrating a slot provided in a heating member according to an embodiment of the present invention.

FIG. 6 is a front view enlarged illustrating a state in which a rotating pin is inserted into a slot provided in a rotating member according to an embodiment of the present invention.

FIG. 7 to FIG. 10 are perspective views illustrating a rotating pin according to various embodiments of the present invention.

FIG. 11 is a cross-sectional view of a massage ball with improved heat transfer performance according to an embodiment of the present invention.

FIG. 12 is a perspective view illustrating a massage ball (equipped with a first insert) with improved heat transfer performance according to another embodiment of the present invention.

FIG. 13 is a cross-sectional view illustrating a massage ball (equipped with a first insert) with improved heat transfer performance according to another embodiment of the present invention.

FIG. 14 is a cross-sectional view illustrating a massage ball (equipped with a second insert) with improved heat transfer performance according to another embodiment of the present invention.

FIG. 15 is a cross-sectional view illustrating a massage ball (equipped with a first insert and a second insert) with improved heat transfer performance according to another embodiment of the present invention.

FIG. 16 is a cross-sectional view illustrating a massage ball (rotating members are alternately disposed in a heating member and outer cover) with improved heat transfer performance according to another embodiment of the present invention.

FIG. 17 is a cross-sectional view illustrating a massage ball (rotating members are disposed simultaneously in a heating member and outer cover) with improved heat transfer performance according to another embodiment of the present invention.

FIG. 18 is a cross-sectional view illustrating a massage ball (rotating members are disposed on an outer cover) with improved heat transfer performance according to another embodiment of the present invention.

FIG. 19 is a cross-sectional view illustrating only an outer cover of a massage ball with improved heat transfer performance according to another embodiment of the present invention.

FIG. 20 is a cross-sectional view of part I-I of FIG. 19 and is a view illustrating a first modified example of the cover slot.

FIG. 21 is a cross-sectional view of the part I-I of FIG. 19 and is a view illustrating a second modified example of the cover slot.

FIG. 22 is a cross-sectional view of the part I-I of FIG. 19 and is a view illustrating a third modified example of the cover slot.

FIG. 23 is a cross-sectional view illustrating a massage ball (equipped with a first insert and second insert) with improved heat transfer performance according to another embodiment of the present invention.

FIG. 24 is a configuration view illustrating a thermal massage device including a massage ball with improved heat transfer performance according to an embodiment of the present invention.

### MODES OF THE INVENTION

Hereinafter, embodiments of the present invention will be described in detail with reference to the accompanying drawings so that those skilled in the art can easily carry out the present invention. The present invention may be embodied in various different forms and is not limited to the embodiments described herein. In order to clearly describe the present invention, parts not related to the description are omitted in the drawings, and the same or similar components are denoted by the same reference numerals throughout the specification.

The words and terms used in the specification and the claims are not interpreted as limited to ordinary or dictionary meanings, but should be interpreted as meanings and concepts corresponding to technical aspects of the present invention according to principles capable of defining terms and concepts by the inventor in order to describe the invention in the best way.

Accordingly, the embodiments described in the present specification and the configurations shown in the drawings correspond to one preferred embodiment of the present invention, and do not represent all of the technical ideas of the present invention, so that the configurations can have various equivalents and modification examples to replace them at the time of application of the present invention.

In this specification, it should be understood that the terms such as “include” or “have” are intended to describe the presence of features, numbers, steps, operations, components, parts or combinations thereof described in the specification, and do not exclude the presence or addition of one or more other features, numbers, steps, operations, components, parts or combinations thereof.

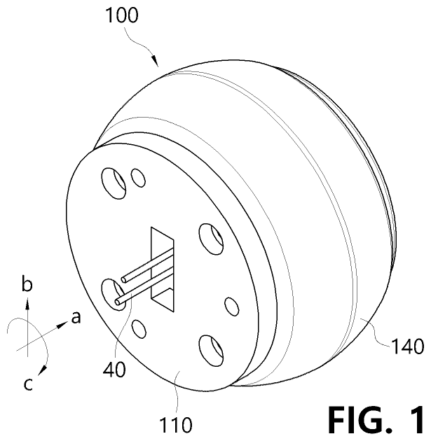

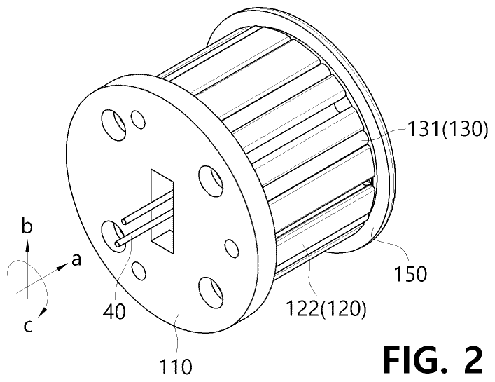

FIG. 1 is a perspective view illustrating an assembled state of a massage ball with improved heat transfer performance according to an embodiment of the present invention, and FIG. 2 is a perspective view illustrating a state in which the outer cover of the massage ball with improved heat transfer performance is removed according to an embodiment of the present invention. Here, (a) direction means an axial direction, (b) direction means a radial direction, and (c) direction means a circumferential direction.

As shown in FIGS. 1 and 2, the massage ball 100 with improved heat transfer performance according to an embodiment of the present invention is a massage ball 100 that provides a thermal massage effect while pressing a user, and the massage ball 100 further includes a heating member 120, a rotating member 130 rotatably inserted into the heating member 120, and an outer cover 140 rotatably disposed on an outer surface of the rotating member 130.

That is, since the rotating member 130 is rotatably inserted into the heating member 120 and the outer cover 140 is rotatably disposed on the outer surface of the rotating member 130, the thermal massage effect is improved as heat is transferred through the rotating member 130 in a conduction manner, and the outer cover 140 may smoothly rotate through the rotating member 130, so that no noise is generated during use, and durability problems due to wear and tear do not occur. The outer cover 140 may be made of an elastic material to reduce pain caused by a pressing force when the massage ball 100 presses the user during the thermal massage. As an example, the outer cover 140 may be made of silicone material.

At this time, the massage ball 100 may include at least one of a first side plate 110 disposed on one side in the axial direction (a) and a second side plate 150 disposed on the other side in the axial direction (a). At this time, the first side plate 110 may be fixedly coupled to the support arm 21. The support arm 21 may be disposed on the support unit 20 provided in a thermal massage device to be described later, and may be configured to rotate at a predetermined angle during the thermal massage process. Since the first side plate 110 is fixedly coupled to the support arm 21, and the heating member 120 is fixedly coupled to the first side plate 110, during the user pressurization process, the massage ball 100 may not only stably support the user's body, but also enable a stable current supply to the heating member 120.

That is, in a state in which the first side plate 110 and the heating member 120 are fixedly coupled to the support arm 21, the rotating member 130 is rotatably inserted into the heating member 120, and the outer cover 140 is rotatably disposed on the outer surface of the rotating member 130.

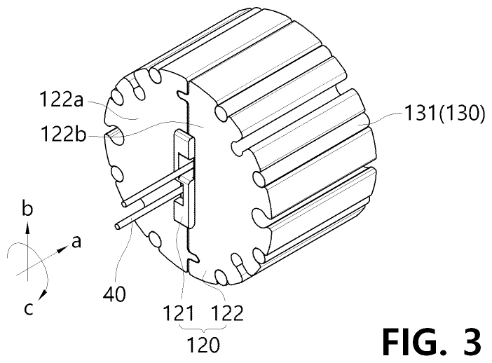

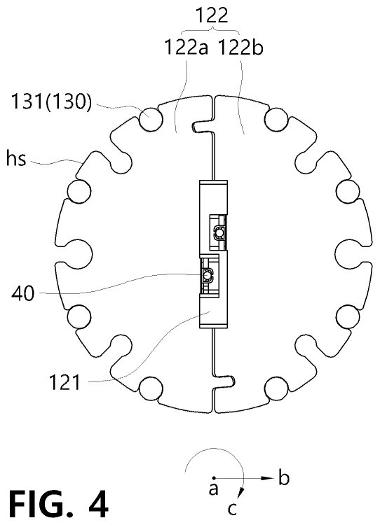

FIG. 3 is a perspective view illustrating a heating member according to an embodiment of the present invention, and FIG. 4 is a front view illustrating a heating member according to an embodiment of the present invention.

As shown in FIGS. 3 and 4, the heating member 120 may include a heater 121 and a heater cover 122 disposed to surround the heater 121 and having a heat transfer surface (hs) on an outer surface thereof.

That is, when the heater 121 generates heat as a current is supplied to the heater 121, the heat is transferred through the heater cover 122 and then transferred to the rotating member 130 through the heat transfer surface (hs). In this way, heat is transferred in a conduction manner, thereby improving a thermal massage effect. In this case, the heater 121 may be a PTC heater, but is not necessarily limited thereto, and may be another configuration such as a heating wire if the configuration is capable of generating heat.

The heater cover 122 may be fixed to the above-described first side plate 110.

As shown in FIGS. 3 and 4, the heater cover 122 includes a first cover 122a disposed on one side in a radial direction (b) and a second cover 122b disposed on the other side in the radial direction (b) and coupled to the first cover 122a, and the heater 121 may be disposed between the first cover 122a and the second cover 122b.

That is, since the first cover 122a and the second cover 122b are configured to be coupled to each other, the heater 121 and the heater cover 122 may be easily coupled to each other, thereby improving productivity. In this case, the first cover 122a may be provided with a coupling protrusion protruding toward the second cover 122b, and the second cover 122b may be provided with a coupling groove into which the coupling protrusion is inserted, and the coupling protrusion and the coupling groove may be configured to be coupled in an interference fit manner. Alternatively, the second cover 122b may be provided with a coupling protrusion, and the first cover 122a may be provided with a coupling groove, and the coupling protrusion and the coupling groove may be configured to be coupled in an interference fit manner.

As shown in FIG. 3, the rotating member 130 may be provided with a rotating pin 131 inserted into the heater cover 122 along the axial direction (a).

In this case, the rotating pin 131 inserted into the heater cover 122 may be configured to rotate relative to the heater cover 122. That is, as the rotating pin 131 is configured to be relatively rotated while inserted into the heater cover 122, the rotation of the outer cover 140 may be more smoothly performed.

In addition, heat may be transferred through the rotating pin 131 in a conduction manner while the outer cover 140 rotates, thereby improving a thermal massage effect.

In this case, a sliding surface may be provided on the outer surface of the heater cover 122. Even if the outer cover 140 is deformed in the process of pressing the user with the massage ball 100 and comes into contact with the heater cover 122, the outer cover 140 may smoothly rotate if the sliding surface is provided.

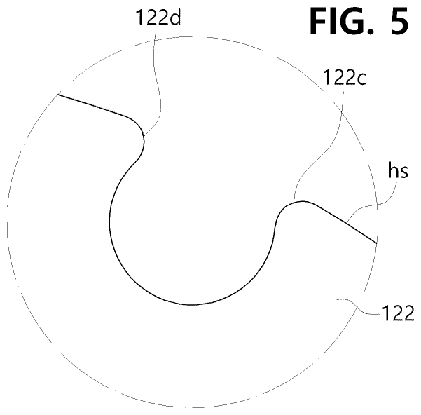

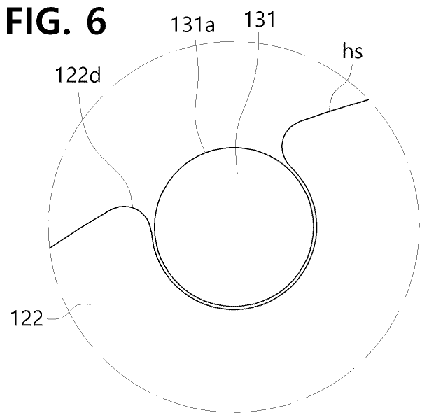

FIG. 5 is a front view enlarged illustrating a slot provided in a heating member according to an embodiment of the present invention, and FIG. 6 is a front view enlarged illustrating a state in which a rotating pin is inserted into a slot provided in a rotating member according to an embodiment of the present invention.

As shown in FIGS. 5 and 6, the heating member 120 may be provided with a slot 122c into which the rotating member 130 is inserted, and an outer opening 122d may be provided outside the radial direction (b) of the slot 122c so that a part of the rotating member 130 is exposed in the radial direction (b).

That is, the rotating pin 131 may be exposed to the outside of the radial direction (b) from the slot 122c through the outer opening 122d, and the portion exposed to the outside of the radial direction (b) makes contact with the outer cover 140 and transfers heat in a conduction manner.

At this time, as described above, a sliding surface may be provided on the outer surface of the heater cover 122, and thus the outer cover 140 may smoothly rotate through the sliding surface even if the outer cover 140 is deformed in the process of pressing the user by the massage ball 100 and is in contact with the heater cover 122.

As shown in FIGS. 5 and 6, the rotating member 130 may be provided with an exposed contact portion 131a that is exposed to the outside of the radial direction (b) through the outer opening 122d.

That is, the exposed contact portion 131a exposed outward in the radial direction (b) is in contact with the outer cover 140 and transfers heat in a conduction manner.

At this time, as described above, a sliding surface may be provided on the outer surface of the heater cover 122, and thus the outer cover 140 may smoothly rotate through the sliding surface even if the outer cover 140 is deformed in the process of pressing the user by the massage ball 100 and is in contact with the heater cover 122.

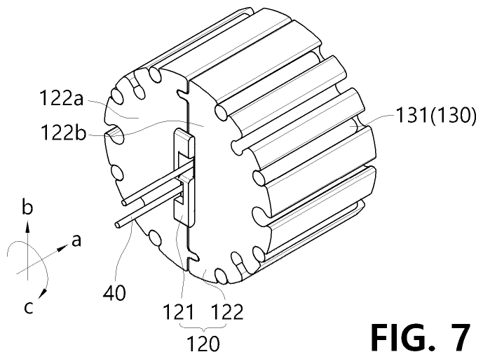

FIG. 7 to FIG. 10 are perspective views illustrating a rotating pin according to various embodiments of the present invention.

In this case, the slot 122c may include at least one of a first slot extending from one side to the other side in a axial direction (a) and a second slot extending from the other side to one side in the axial direction (a).

For example, as shown in FIG. 7, the slot 122c may include a first slot extending from one side to the other side in the axial direction (a). In this case, a separation prevention surface that blocks the separation of the rotating pin 131 may be provided on the other side of the slot 122c in the axial direction (a). With this configuration, the operator may simply assemble the rotating pin 131 from one side to the other side in the axial direction (a), thereby improving assemblyability.

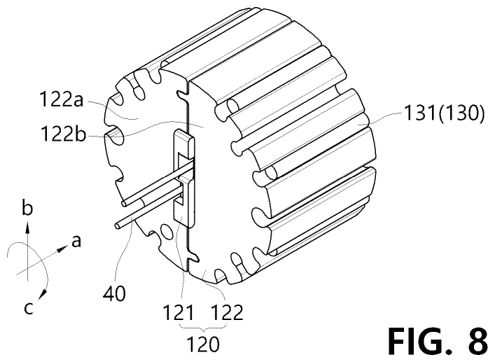

As another example, as shown in FIG. 8, the slot 122c may include a second slot extending from the other side to one side in the axial direction (a). In this case, a separation prevention surface that blocks the separation of the rotating pin 131 may be provided on one side of the slot 122c in the axial direction (a). With this configuration, the operator may simply assemble the rotating pin 131 from the other side to the one side in the axial direction (a), thereby improving assemblyability.

In this case, the slot 122c includes a first slot extending from one side to the other side in the axial direction (a) and a second slot extending from the other side to one side in the axial direction, and the first slot and the second slot may be alternately disposed along a circumferential direction (c) or may be disposed along the axial direction (a).

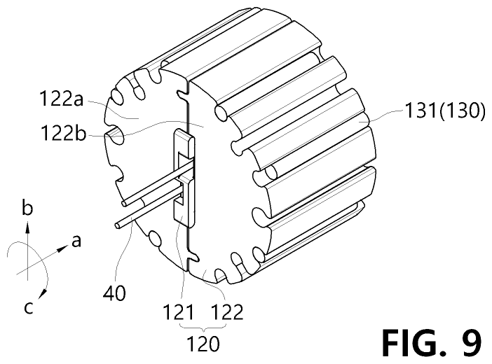

As an example, as shown in FIG. 9, the slot 122c includes a first slot extending from one side to the other side in the axial direction (a) and a second slot extending from the other side to one side in the axial direction (a), and the first slot and the second slot may be alternately disposed along the circumferential direction (c). With this configuration, one side of the outer cover 140 in the axial direction (a) is supported by the rotating pin 131 inserted into the first slot, and the other side of the outer cover 140 in the axial direction (a) is supported by the rotating pin 131 inserted into the second slot, so that the outer cover 140 may smoothly rotate.

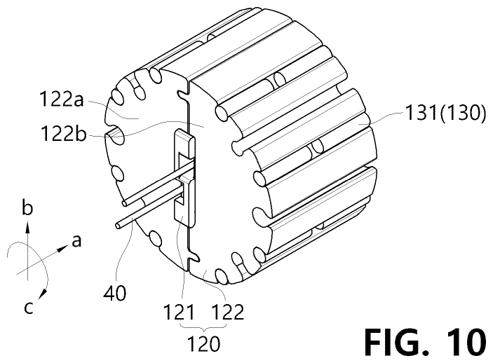

As another example, as shown in FIG. 10, the slot 122c includes a first slot extending from one side to the other side in the axial direction (a) and a second slot extending from the other side to one side in the axial direction (a), and the first slot and the second slot may be disposed along the axial direction (a). With this configuration, one side of the outer cover 140 in the axial direction (a) is supported by the rotating pin 131 inserted into the first slot, and the other side of the outer cover 140 in the axial direction (a) is supported by the rotating pin 131 inserted into the second slot, so that the outer cover 140 may smoothly rotate.

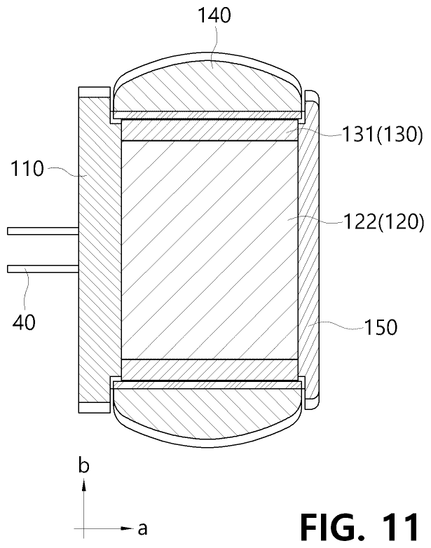

FIG. 11 is a cross-sectional view of a massage ball with improved heat transfer performance according to an embodiment of the present invention.

As shown in FIG. 11, the massage ball 100 may further include a second side plate 150 disposed opposite to the first side plate 110. When the second side plate 150 is provided in this way, it is possible to prevent the rotating member 130 and the outer cover 140 from randomly leaving in the axial direction (a) during relative rotation with the heating member 120.

At this time, the second side plate 150 may be configured to be disposed inside the radial direction (b) of the outer cover 140, with this configuration, it is possible to minimize foreign body sensation that may be felt due to the second side plate 150 while the massage ball 100 presses the user.

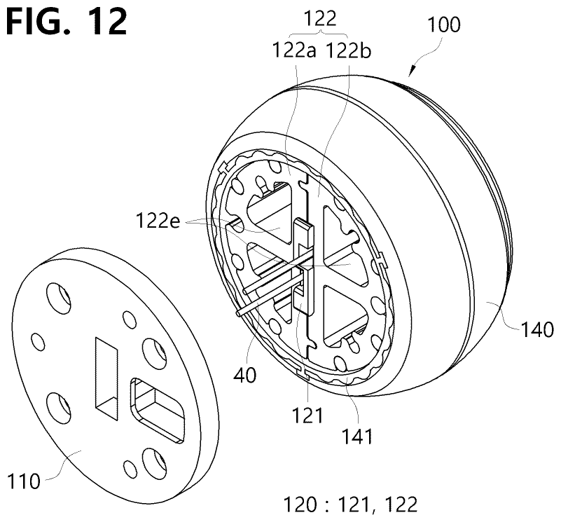

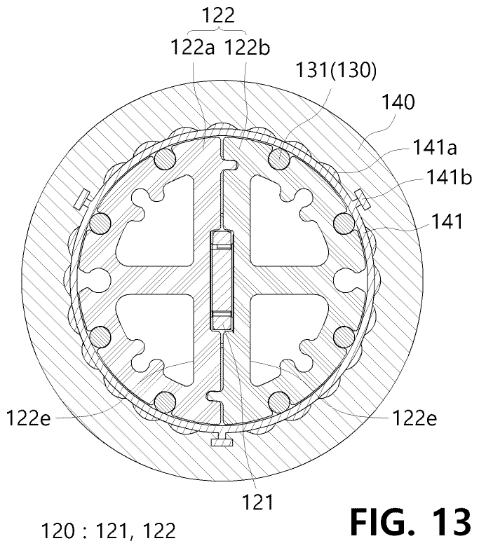

FIG. 12 is a perspective view illustrating a massage ball (equipped with a first insert) with improved heat transfer performance according to another embodiment of the present invention, and FIG. 13 is a cross-sectional view illustrating a massage ball (equipped with a first insert) with improved heat transfer performance according to another embodiment of the present invention.

As shown in FIGS. 12 and 13, the heater cover 122 may be provided with an opening hole 122e extending along the axial direction (a). Heat generated from the heater 121 moves in a conduction manner through the heater cover 122, and when an opening hole 122e is provided in the heater cover 122, an air layer is formed at the position of the opening hole 122e, the heat moving in the conduction manner moves only to the remaining portions where the opening hole 122e is not formed. This is because heat to flow in a direction where resistance is less formed. With this configuration, it is possible to quickly heat the outer cover 140 through the rotating member 130.

In this case, as shown in FIGS. 12 and 13, the inner surface of the outer cover 140 may be provided with a first insert 141. The first insert 141 may be made of aluminum having high heat transfer performance so that the heat transferred through the rotating member 130 may smoothly move to the outer cover 140, but it is not necessarily limited to this, and any material may be used as long as it has high heat transfer performance. The first insert 141 may be provided integrally with an insert injection method during the process of injection molding the outer cover 140.

In addition, the first insert 141 may be formed to extend from one end to the other end in the axial direction (a) of the outer cover 140 to secure structural stability while supporting the inner surface of the outer cover 140, and through this, the outer cover 140 may be easily assembled during the manufacturing process of the massage ball 100 and it is also possible to stably support road even if the user's load is applied to the massage ball 100 during the thermal massage process.

In addition, a sliding surface may be provided on the inner surface of the first insert 141, and if the sliding surface is provided in this way, the outer cover 140 may smoothly rotate.

In this case, the first insert 141 may be provided with a first transmission protrusion 141a protruding outward in the radial direction (b), and a plurality of first transmission protrusions 141a may be provided along the circumferential direction (c) of the first insert 141. Through this, heat transferred to the first insert 141 may be smoothly transferred to the outer cover 140. As an example, the first transfer protrusion 141a may be curved in a convex shape, but it is not necessarily limited to this, and may have any shape as long as it can transfer heat through conduction.

In addition, the first insert 141 may be provided with a first fixing protrusion 141b protruding outward in the radial direction (b), and a curved surface is formed in the first fixing protrusion 141b to prevent the first insert 141 from being easily separated from the outer cover 140, thereby improving structural stability.

The first transfer protrusion 141a and the first fixing protrusion 141b may be integrally formed during the manufacture of the first insert 141, but the first transfer protrusion 141a and the first fixing protrusion 141b separated separately may be configured by attaching the first transfer protrusion 141a and the first fixing protrusion 141b to the first insert 141.

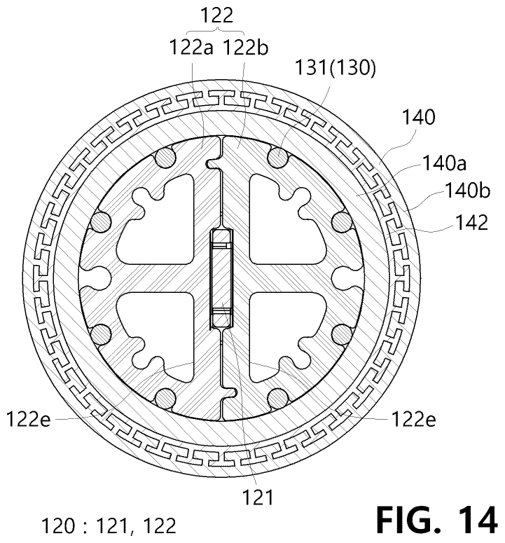

FIG. 14 is a cross-sectional view illustrating a massage ball (equipped with a second insert) with improved heat transfer performance according to another embodiment of the present invention.

The second insert 142 may be provided in the central portion of the outer cover 140 in the axial direction (a). In other words, the central portion of the outer cover 140 in the axial direction (a) is thickly formed to provide a sufficient cushioning effect to the user, and the thermal sensation provided to the user is inevitably deteriorated due to the thickness of the outer cover 140. Therefore, when the second insert 142 is provided inside the outer cover 140, heat transferred to the inner surface of the outer cover 140 may be smoothly transferred to the outer surface of the outer cover 140 through the second insert 142.

In addition, when the second insert 142 reaches a thermal saturation state, even if the supply of heat through the heater 121 is stopped for a predetermined time, it is possible to provide a continuous thermal sensation to the user through the second insert 142.

In this case, the first cushion layer 140a may be provided on the inside of the outer cover 140 in the radial direction (b), and the second cushion layer 140b may be provided on the outside of the outer cover 140 in the radial direction (b) based on the second insert 142. In this way, when the first cushion layer 140a and the second cushion layer 140b are provided, the second insert 142 may minimize the foreign body sensation that the user may feel and provide sufficient cushioning effect to the user.

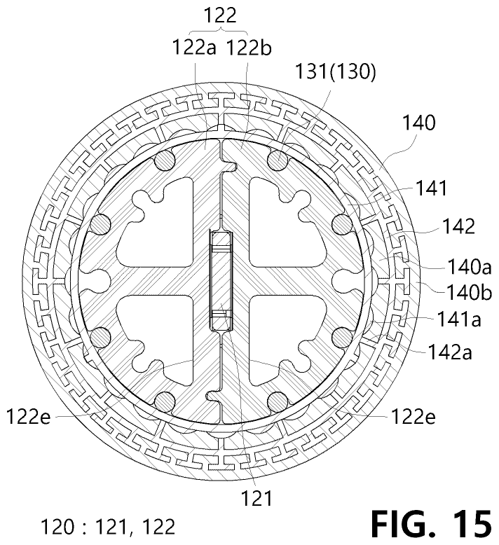

FIG. 15 is a cross-sectional view illustrating a massage ball (equipped with a first insert and a second insert) with improved heat transfer performance according to another embodiment of the present invention.

As shown in FIG. 15, a first insert 141 may be provided on the inner surface of the outer cover 140, and a second insert 142 may be provided on the central portion of the axial direction (a) of the outer cover 140. The specific configurations of the first insert 141 and the second insert 142 are as described above.

However, the first insert 141 and the second insert 142 may be connected to each other in the radial direction (b). As described above, when the first insert 141 and the second insert 142 are connected to each other in the radial direction (b), the structural stability of the outer cover 140 is improved.

In addition, in a state in which the first insert 141 and the second insert 142 are connected to each other in the radial direction (b), the first cushion layer 140a may be provided between the first insert 141 and the second insert 142, and the second cushion layer 140b may be provided on the outside of the outer cover 140 in the radial direction (b). In this way, when the first cushion layer 140a and the second cushion layer 140b are provided, the first insert 141 and the second insert 142 may minimize the foreign body sensation that the user may feel and provide sufficient cushioning effect to the user.

In this case, the first insert 141 may be provided with a first transmission protrusion 141a protruding outward in the radial direction (b), and a plurality of first transmission protrusions 141a may be provided along the circumferential direction (c) of the first insert 141. Through this, heat transferred to the first insert 141 may be smoothly transferred to the outer cover 140. As an example, the first transfer protrusion 141a may be curved in a convex shape, but it is not necessarily limited to this, and may have any shape as long as it may transfer heat through conduction.

In addition, the second insert 142 may be provided with a second fixing protrusion 142a protruding inward in the radial direction (b), and the second fixing protrusion 142a is connected to the first insert 141 so that the first insert 141 and the second insert 142 are not easily separated from the outer cover 140, thereby improving structural stability.

The first transmission protrusion 141a may be integrally formed during the manufacture of the first insert 141, but it is also possible to attach the separately separated first transmission protrusion 141a to the first insert 141. In addition, the second fixing protrusion 142a may be integrally formed during the manufacturing of the second insert 142, but it is also possible to attach the separately separated second fixing protrusion 142a to the second insert 142.

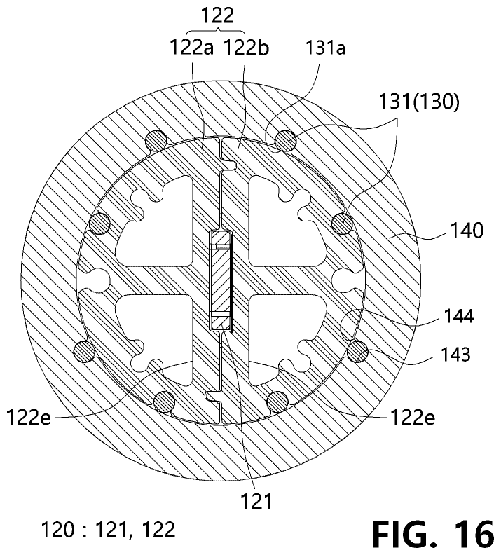

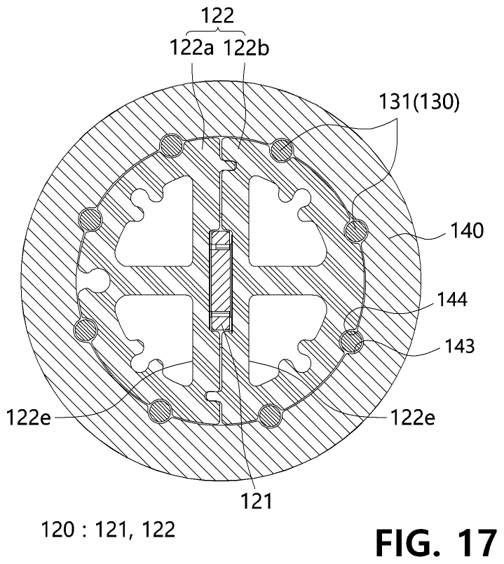

FIG. 16 is a cross-sectional view illustrating a massage ball (rotating members are alternately disposed in a heating member and outer cover) with improved heat transfer performance according to another embodiment of the present invention, and FIG. 17 is a cross-sectional view illustrating a massage ball (rotating members are disposed simultaneously in a heating member and outer cover) with improved heat transfer performance according to another embodiment of the present invention.

In this case, the rotating member 130 may be inserted into the heating member 120 and the outer cover 140. That is, as shown in FIG. 16, the rotating member 130 may be alternately disposed in the heating member 120 and the outer cover 140 along the circumferential direction (c). The rotating member 130 inserted into the heating member 120 is partially exposed outward in the radial direction (b) toward the outer cover 140 and comes into contact with the outer cover 140, and the rotating member 130 inserted into the outer cover 140 is partially exposed inward in the radial direction (b) toward the heating member 120 and comes into contact with the heating member 120. With this configuration, the thermal massage effect may be improved as the heat generated from the heating member 120 is transferred through the rotating member 130 in a conduction manner, and the outer cover 140 may smoothly rotate.

Alternatively, as shown in FIG. 17, the rotating member 130 may be disposed simultaneously in the heating member 120 and the outer cover 140. That is, a part of the rotating member 130 is inserted into the heating member 120, and the remaining part of the rotating member 130 is inserted into the outer cover 140. With this configuration, as the heat generated from the heating member 120 is transferred through the rotating member 130 in a conduction manner, the thermal massage effect may be improved. At this time, the rotating member 130 may be partially exposed between the heating member 120 and the outer cover 140. With this configuration, as the heating member 120 and the outer cover 140 are spaced apart from each other, the outer cover 140 may smoothly rotate.

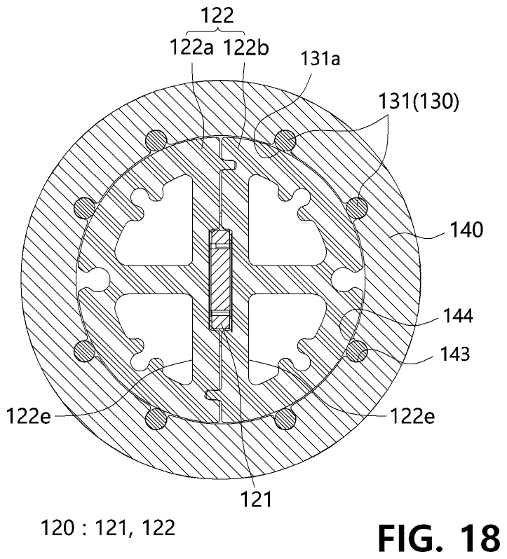

FIG. 18 is a cross-sectional view illustrating a massage ball (rotating members are disposed on an outer cover) with improved heat transfer performance according to another embodiment of the present invention.

As shown in FIG. 18, the massage ball 100 with improved heat transfer performance according to another embodiment of the present invention is a massage ball 100 that provides a thermal massage effect while pressing a user, and the massage ball 100 includes a heating member 120, an outer cover 140 rotatably disposed on an outer surface of the heating member 120, and a rotating member 130 rotatably inserted into the outer cover 140. That is, the rotating member 130 inserted into the outer cover 140 is partially exposed inward in the radial direction (b) toward the heating member 120 and comes into contact with the heating member 120. With this configuration, as the heat generated from the heating member 120 is transferred through the rotating member 130 in a conduction manner, the thermal massage effect may be improved, and the outer cover 140 may smoothly rotate.

As shown in FIG. 18, the heating member 120 may include a heater 121 and a heater cover 122 disposed to surround the heater 121 and having a heat transfer surface (hs) on an outer surface thereof. The heater 121 and the heater cover 122 may be the same configuration as the above-described configuration.

As shown in FIG. 18, the heater cover 122 includes a first cover 122a disposed on one side in the radial direction (b) and a second cover 122b disposed on the other side in the radial direction (b) and coupled with the first cover 122a, and the heater 121 may be disposed between the first cover and the second cover. The first cover 122a and the second cover 122b may be the same configuration as the above-described configuration.

As shown in FIG. 18, the rotating member 130 may be provided with a rotating pin 131 inserted into the outer cover 140 along the axial direction (a).

At this time, the rotating pin 131 inserted into the outer cover 140 may be configured to rotate relative to the outer cover 140. That is, as the rotating pin 131 is configured to rotate relative to the outer cover 140 while inserted into the outer cover 140, the outer cover 140 may more smoothly rotate.

In addition, heat may be transferred through the rotating pin 131 in a conduction manner while the outer cover 140 rotates, thereby improving a thermal massage effect.

At this time, a sliding surface may be provided on the inner surface of the outer cover 140. Even if the outer cover 140 is deformed in the process of pressing the user by the massage ball 100 and in contact with the heater cover 122, the outer cover 140 may smoothly rotate if the sliding surface is provided.

As shown in FIG. 18, the outer cover 140 may be provided with a cover slot 143 into which the rotating member 130 is inserted, and a cover opening 144 may be provided inside the cover slot 143 in the radial direction (b) so that a portion of the rotating member 130 is exposed in the radial direction (b).

In other words, the rotating member 130 may be exposed inside the cover slot 143 in the radial direction (b) through the cover opening 144, and the portion exposed inward in the radial direction (b) is in contact with the heater cover 122 and receives heat in a conduction manner.

As illustrated in FIG. 18, the rotating member 130 may be provided with an exposed contact portion 131a that is exposed inward in the radial direction (b) through the cover opening 144.

That is, the exposed contact portion 131a exposed outward in the radial direction (b) is in contact with the outer cover 140 and transfers heat in a conduction manner.

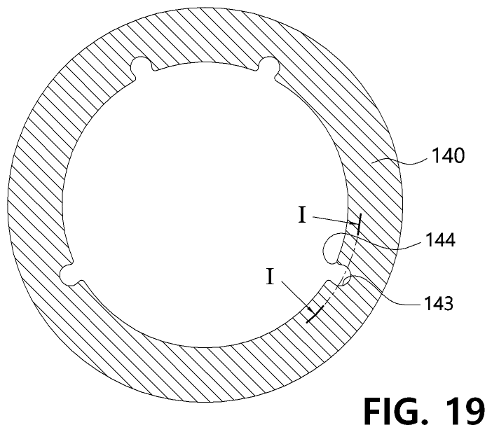

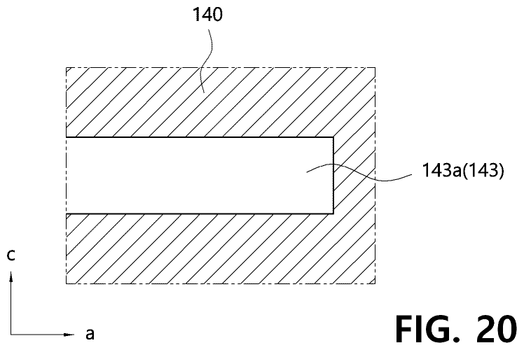

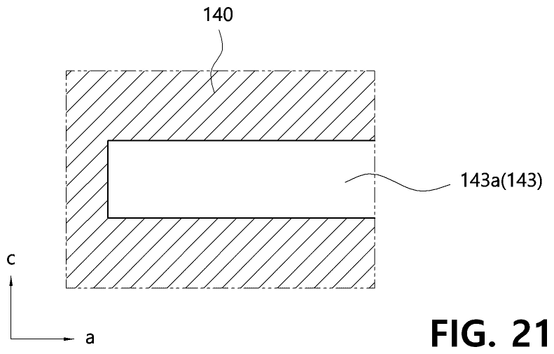

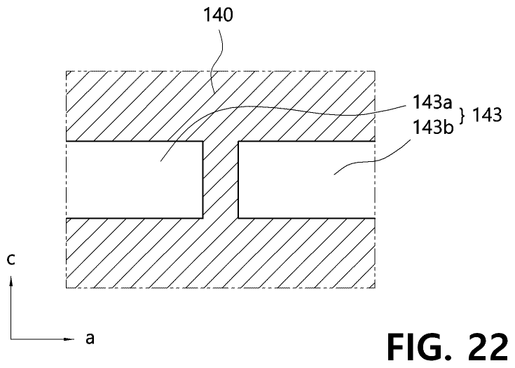

FIG. 19 is a cross-sectional view illustrating only an outer cover of a massage ball with improved heat transfer performance according to another embodiment of the present invention, FIG. 20 is a cross-sectional view of part I-I of FIG. 19 and is a view illustrating a first modified example of the cover slot, FIG. 21 is a cross-sectional view of the part I-I of FIG. 19 and is a view illustrating a second modified example of the cover slot, and FIG. 22 is a cross-sectional view of the part I-I of FIG. 19 and is a view illustrating a third modified example of the cover slot.

As shown in FIGS. 19 to 22, the cover slot 143 may include at least one of a first cover slot 143a extending from one side to the other side in the axial direction (a) and a second cover slot 143b extending from the other side to one side in the axial direction (a).

As an example, as shown in FIG. 20, the cover slot 143 may include a first cover slot 143a extending from one side to the other side in the axial direction (a). In this case, a separation prevention surface that blocks the separation of the rotating pin 131 may be provided on the other side of the first cover slot 143a in the axial direction (a). With this configuration, the operator may simply assemble the rotating pin 131 from one side to the other side in the axial direction (a), thereby improving assemblyability.

As another example, as shown in FIG. 21, the cover slot 143 may include a second cover slot 143b extending from the other side to one side in the axial direction (a). In this case, a separation prevention surface that blocks the separation of the rotating pin 131 may be provided on one side of the second cover slot 143b in the axial direction (a). With this configuration, the operator may simply assemble the rotating pin 131 from the other side to the one side in the axial direction (a), thereby improving assemblyability.

In this case, the cover slot 143 includes a first cover slot 143a extending from one side to the other side in the axial direction (a) and a second cover slot 143b extending from the other side to one side in the axial direction (a), and the first cover slot 143a and the second cover slot 143b may be alternately disposed along the circumferential direction (c) or may be disposed along the axial direction (a).

As an example, the cover slot 143 includes a first cover slot 143a extending from one side to the other side in the axial direction (a) and a second cover slot 143b extending from the other side to one side in the axial direction (a), wherein the first cover slot 143a and the second cover slot 143b may be alternately disposed along the circumferential direction (c). With this configuration, one side of the outer cover 140 in the axial direction (a) is supported by the rotating pin 131 inserted into the first cover slot 143a, and the other side of the outer cover 140 in the axial direction (a) is supported by the rotating pin 131 inserted into the second cover slot 143b, so that the outer cover 140 may smoothly rotate.

As another example, as shown in FIG. 22, the cover slot 143 includes a first cover slot 143a extending from one side to the other side in the axial direction (a) and a second cover slot 143b extending from the other side to one side in the axial direction (a), and the first cover slot 143a and the second cover slot 143b may be disposed along the axial direction (a). With this configuration, one side of the outer cover 140 in the axial direction (a) is supported by the rotating pin 131 inserted into the first cover slot 143a, and the other side of the outer cover 140 in the axial direction (a) is supported by the rotating pin 131 inserted into the second cover slot 143b, so that the outer cover 140 may smoothly rotate.

In this case, the massage ball 100 may further include at least one of a first side plate 110 disposed on one side in the axial direction (a) and a second side plate 150 disposed on the other side in the axial direction (a). The first side plate 110 and the second side plate 150 may be the same as the above-described configuration.

As shown in FIG. 18, the heater cover 122 may be provided with an opening hole 122e extending along the axial direction (a). The heater cover 122 may be the same as the above-described configuration.

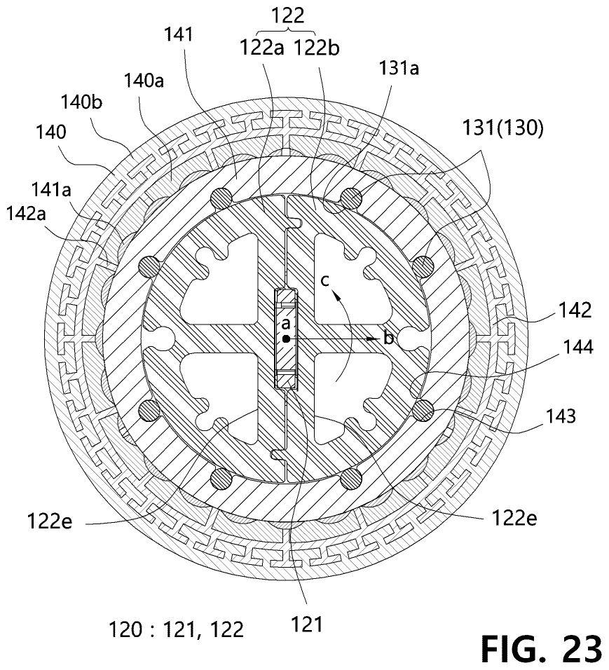

FIG. 23 is a cross-sectional view illustrating a massage ball (equipped with a first insert and second insert) with improved heat transfer performance according to another embodiment of the present invention.

As shown in FIG. 23, a first insert 141 may be provided on an inner surface of the outer cover 140. At this time, the first insert 141 may be provided with a cover slot 143 in which the rotating member 130 is disposed. In addition, a second insert 142 may be provided in a central portion of the outer cover 140 in the axial direction (a). The first insert 141 and the second insert 142 may be the same as the above-described configuration.

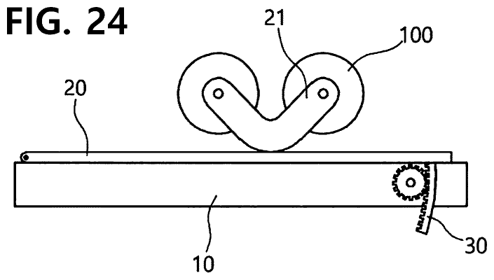

FIG. 24 is a configuration view illustrating a thermal massage device including a massage ball with improved heat transfer performance according to an embodiment of the present invention.

As shown in FIG. 24, a thermal massage device including a massage ball 100 with improved heat transfer performance according to an embodiment of the present invention includes a transport unit 10 that moves the massage ball 100 pressing the user in the longitudinal direction, a support unit 20 provided with a support arm 21 to which a massage ball 100 is fixedly coupled, an elevating unit 30 ascending or descending the support unit 20 in the height direction, and a power supply unit 40 that supplies current to the massage ball 100.

The thermal massage device may be inserted and disposed into a pad that supports the user's body, and the thermal massage device pressurizes the user's body while moving in a longitudinal direction (the same direction as the user's spine alignment direction) while being inserted into the pad.

The pad may be provided in a main body portion that supports the user's upper body, and an auxiliary portion that supports the user's lower body may be connected to the main body portion. In this case, the main body portion may be configured to support not only the upper body but also the buttocks of the user, and the auxiliary portion may be configured to support only the legs of the user.

In this case, the pad may be provided in an auxiliary portion that supports the lower body of the user, and it is also possible to configure the pad to be provided in both the main body portion and the auxiliary portion.

The main body portion with the pad may be provided with a separate leg member so that the upper surface of the pad is spaced from the ground, allowing the user to receive a massage in a comfortable position.

The leg member may be manufactured in a substantially rectangular band shape. That is, it may include a side frame corresponding to the side surface of the main body portion, a lower frame supported on the ground, and a connecting frame connecting the side frame and the lower frame. The frames may be manufactured integrally or separately manufactured and then combined. Here, the side frame may be manufactured in a plate shape, and the lower frame may be manufactured in a rod shape.

A guide groove is formed in the aforementioned main body portion, and a guide protrusion inserted into the guide groove is formed in the auxiliary portion, so that the auxiliary portion may be configured to slide. Alternatively, it is also possible to form a guide groove in the auxiliary portion and a guide protrusion in the main body portion to allow the auxiliary portion to slide.

The massage ball 100 may be disposed on both sides in the width direction (both sides of the spine of the user), respectively, thereby providing a massage effect while pressurizing the blood spots (for example, the blood spots according to bladder meridian) located on both sides along the spine of the user.

At this time, the transport unit 10 may be provided with a plate-shaped transport plate member in which the support unit 20 and the elevating unit 30 are disposed, and base ribs may be provided on both ends in the width direction of the transport plate member. The base rib may be provided with a support roller, and the support roller may be disposed to be movable along a guide rail disposed along the longitudinal direction. In addition, the transport unit 10 may be provided with a transfer driving member providing a driving force so that the support roller moves along the guide rail.

In addition, the support arm 21 may be disposed to be rotatable at a predetermined angle on the support unit 20. The elevating unit 30 may be provided with a rack gear-shaped ascending and descending member and a pinion gear-shaped ascending and descending driving member, and a separate driving motor may be connected to the ascending and descending member driving member to allow the ascending and descending member to ascend or descend in accordance with one direction or the rotation of the other direction.

In addition, the massage ball 100 may be provided with a power supply unit 40 to supply current, and if current is supplied to the heating member 120 through this, the heating member 120 may generate heat.

As shown in FIGS. 1 and 2, the massage ball 100 providing a thermal massage effect while pressing a user, the massage ball 100 includes a first side plate 110 fixedly coupled to the support arm 21, a heating member 120 fixedly coupled to the first side plate 110, a rotating member 130 rotatably inserted and disposed into an outer surface of the heating member 120, and an outer cover 140 rotatably disposed on the outer surface of the rotating member 130. The detailed configuration of the massage ball 100 is the same as the above-described configuration, and thus detailed descriptions thereof will be omitted.

As described above, the massage ball with improved heat transfer performance according to an embodiment of the present invention is provided with the rotating member 130 rotatably inserted into the heating member 120 and the outer cover 140 rotatably disposed on the outer surface of the rotating member 130, and thus improving the thermal massage effect as heat is transferred through the rotating member 130 in a conduction manner, so that no noise is generated during use, and durability problems due to wear and tear do not occur.

In the case of the massage ball with improved heat transfer performance according to one embodiment, another embodiment, and still another embodiment of the present invention described above, each embodiment is separately described, but the features of each embodiment may be performed in combination with each other.

Although the present invention has been described above, the spirit of the present invention is not limited by the embodiments presented in the specification, and those skilled in the art who understand the spirit of the present invention may easily propose other embodiments by adding, modifying, deleting, adding, etc., elements within the same spirit, but the spirit of the present invention is also given.

1. A massage ball with improved heat transfer performance, the massage ball providing a thermal massage effect while pressing a user, the massage ball comprising:
a heating member;
a rotating member rotatably inserted into the heating member; and
an outer cover rotatably disposed on an outer surface of the rotating member.

2. The massage ball of claim 1, wherein the heating member includes:
a heater; and
a heater cover disposed to surround the heater, and having a heat transfer surface on an outer surface thereof.

3. The massage ball of claim 2, wherein the heater cover includes:
a first cover disposed on one side in a radial direction, and
a second cover disposed on the other side in the radial direction and coupled to the first cover, and
wherein the heater is disposed between the first cover and the second cover.

4. The massage ball of claim 2, wherein the rotating member is provided with a rotating pin inserted into the heater cover along an axial direction.

5. The massage ball of claim 1, wherein:
the heating member is provided with a slot into which the rotating member is inserted, and
an outer opening is provided outside a radial direction of the slot so that a part of the rotating member is exposed in the radial direction.

6. The massage ball of claim 5, wherein the rotating member is provided with an exposed contact portion that is exposed to the outside of the radial direction through the outer opening.

7. The massage ball of claim 5, wherein the slot includes at least one of:
a first slot extending from one side to the other side in an axial direction, and
a second slot extending from the other side to the one side in the axial direction.

8. The massage ball of claim 5, wherein the slot includes:
a first slot extending from one side to the other side in an axial direction, and
a second slot extending from the other side to the one side in the axial direction, and
wherein the first slot and the second slot are alternately disposed along a circumferential direction or disposed along the axial direction.

9. The massage ball of claim 1, wherein the massage ball further includes at least one of:
a first side plate disposed on one side in an axial direction, and
a second side plate disposed on the other side in the axial direction.

10. The massage ball of claim 2, wherein the heater cover is provided with an opening hole extending along an axial direction.

11. The massage ball of claim 1, wherein a first insert is provided on an inner surface of the outer cover.

12. The massage ball of claim 1, wherein a second insert is provided in a central portion of the outer cover in an axial direction.

13. The massage ball of claim 12, wherein:
a first cushion layer is provided on the inside of the outer cover in a radial direction based on the second insert, and
a second cushion layer is provided on the outside of the outer cover in the radial direction.

14. The massage ball of claim 1, wherein:
a first insert is provided on an inner surface of the outer cover, and
a second insert is provided in a central portion of the outer cover in an axial direction.

15. The massage ball of claim 14, wherein:
a first cushion layer is provided between the first insert and the second insert, and
a second cushion layer is provided on the outside of the outer cover in a radial direction.

16. The massage ball of claim 1, wherein the rotating member is inserted into the heating member and the outer cover.

17. A massage ball with improved heat transfer performance, the massage ball providing a thermal massage effect while pressing a user, the massage ball comprising:
a heating member;
an outer cover rotatably disposed on an outer surface of the heating member; and
a rotating member rotatably inserted into the outer cover.

18. The massage ball of claim 17, wherein the heating member includes:
a heater; and
a heater cover disposed to surround the heater, and having a heat transfer surface on an outer surface thereof.

19. The massage ball of claim 18, wherein the heater cover includes:
a first cover disposed on one side in a radial direction, and
a second cover disposed on the other side in the radial direction and coupled to the first cover, and
wherein the heater is disposed between the first cover and the second cover.

20. The massage ball of claim 18, wherein the rotating member is provided with a rotating pin inserted into the outer cover along an axial direction.

21. The massage ball of claim 17, wherein:
the outer cover is provided with a cover slot into which the rotating member is inserted, and
a cover opening is provided inside a radial direction of the cover slot so that a part of the rotating member is exposed in the radial direction.

22. The massage ball of claim 21, wherein the rotating member is provided with an exposed contact portion that is exposed inward in the radial direction through the cover opening.

23. The massage ball of claim 21, wherein the cover slot includes at least one of:
a first cover slot extending from one side to the other side in an axial direction, and
a second cover slot extending from the other side to the one side in the axial direction.

24. The massage ball of claim 21, wherein the cover slot includes:
a first cover slot extending from one side to the other side in an axial direction, and
a second cover slot extending from the other side to the one side in the axial direction, and
wherein the first cover slot and the second cover slot are alternately disposed along a circumferential direction or disposed along the axial direction.

25. The massage ball of claim 17, wherein the massage ball further includes at least one of:
a first side plate disposed on one side in an axial direction, and
a second side plate disposed on the other side in the axial direction.

26. The massage ball of claim 18, wherein the heater cover is provided with an opening hole extending along an axial direction.

27. The massage ball of claim 17, wherein a first insert is provided on an inner surface of the outer cover.

28. The massage ball of claim 17, wherein a second insert is provided in a central portion of the outer cover in an axial direction.

29. The massage ball of claim 28, wherein:
a first cushion layer is provided on the inside of the outer cover in a radial direction based on the second insert, and
a second cushion layer is provided on the outside of the outer cover in the radial direction.

30. The massage ball of claim 17, wherein:
a first insert is provided on an inner surface of the outer cover, and
a second insert is provided in a central portion of the outer cover in an axial direction.

31. The massage ball of claim 30, wherein:
a first cushion layer is provided between the first insert and the second insert, and
a second cushion layer is provided on the outside of the outer cover in a radial direction.
